(19) United States
(12) Patent Application Publication
(10) Pub. No.: US 2023/0334604 A1
(43) Pub. Date: Oct. 19, 2023

(54) CONTRACT MANAGEMENT SYSTEM

(71) Applicant: Taylor Francis, Fergus (CA)

(72) Inventor: Taylor Francis, Fergus (CA)

(21) Appl. No.: 17/720,237

(22) Filed: Apr. 13, 2022

(51) Int. Cl. G06Q 10/10; G06Q 50/18

(52) U.S. Cl. CPC G06Q 50/18; G06Q 10/103

(57) ABSTRACT

A contract management system for facilitating and managing a contract between two users includes a user interface adapted to be accessed via a user device to facilitate a first user to input a plurality of details associated with the contract and upload at least one initial file describing the project. The contract management system also includes a processor to create a contract document by generating a document based on the plurality of details received from the user interface, and associating the at least one initial file with the document. The processor is also configured to share the contract document with a second user of the two users and receive the electronic signature of the two users, via the user interface, on the contract document to execute the contract between the two users.

### TECHNICAL FIELD

The present disclosure relates, generally, to a contract management system. More particularly, the present disclosure pertains to a contract management system that facilitates a creation and management of a mutually binding contract between the users.

### BACKGROUND

Contract construction and mutual negotiation is a vital part of any business or carrying out any work/project. Most contracts are complex and need professional experts to prepare such contracts, thereby increasing the cost of the overall process. However, for small-scale or small transactions, it difficult for the customer and vendor to create the expensive legally binding contracts.

### SUMMARY

According to an aspect of a disclosure, a contract management system for facilitating and managing a contract between two users related to a project is disclosed. The contract management system includes a user interface adapted to be accessed by a user device to facilitate one of the two users to input a plurality of details associated with the contract and upload at least one initial file describing the project. The contract management system also includes a processor arranged in communication with the user interface and is configured to create a contract document by generating a document based on the plurality of details received from the user interface, and associating the at least one initial file with the document. The processor is also configured to share the contract document with another of the two users and receive the electronic signature of the two users, via the user interface, on the contract document to execute the contract between the two users.

In some embodiment, the plurality of details includes at least one detail of a first user of the two users, at least one detail of a second user of the two users, and at least one detail of the project.

In some embodiments, the at least one detail of the first user includes one or more of a name of the first user, an address of the first user, and a contact number of the first user.

In some embodiments, the at least one detail of the second user includes one or more of a name of the second user, an address of the second user, and a contact number of the second user.

In some embodiments, the at least one detail of the project includes one or more of a description of the work to be performed in the project, a location at which the project is to be completed, a timeline associated with a start of the project, a timeline associated with a completion of the project, a timeline of a completion of the project, a cost associated with the project, and payment terms.

In some embodiments, the contract management system further includes a contract module having at least one contract template, and the processor generates the document by using the at least one contract template.

In some embodiments, the contract management system further includes an account module having a first account associated with one of the two users and a second account associated with other of the two users. The processor associates the contract document with the first account and the second account to enable an access of the contract document by the two users via the user interface.

In some embodiments, the processor is configured to receive at least one completion file via the user interface and determine a level of completion of the project based on the at least one completion file.

In some embodiments, the processor determines the completion of the project upon a receipt of the approval from one of the two users, via the user interface, based on the at least one completion file.

In some embodiments, the processor is configured to receive payment details from one of the two users upon completion or partial completion of the project via the user interface and associates the payment details with the contract document.

According to an aspect of the disclosure, a method for facilitating and managing a contract between two users related to a project is disclosed. The method includes receiving, by a processor, a plurality of details associated with the contract and at least one initial file describing the project via a user interface. The method also includes creating, by the processor, a contract document by generating a document based on the plurality of details, and associating the at least one initial file with the document. The method further includes sharing, by the processor, the contract document with at least one of the two users. Moreover, the method includes receiving, by the processor, authentications from the two users, via the user interface, on the contract document to execute the contract between the two users.

In some embodiments, the plurality of details includes at least one detail of a first user of the two users, at least one detail of a second user of the two users, and at least one detail of the project.

In some embodiments, the at least one detail of the first user includes one or more of a name of the first user, an address of the first user, and a contact number of the first user.

In some embodiments, the at least one detail of the second user includes one or more of a name of the second user, an address of the second user, and a contact number of the second user.

In some embodiments, the at least one detail of the project includes one or more of a description of the work to be performed in the project, a location at which the project is to be completed, a timeline associated with a start of the project, a timeline associated with a completion of the project, a timeline of a completion of the project, a cost associated with the project, and payment terms.

In some embodiments, the processor generates the document by using the at least one contract template received from a contract module.

In some embodiments, the processor associates the contract document with a first account associated with one of the two users and a second account associated with other of the two users to enable an access of the contract document to the two users via the user interface, wherein processor access an account module to access the first account and the second account.

In some embodiments, the method further includes receiving, by the processor, at least one completion file via the user interface, and determining, by the processor, a level of completion of the project based on the at least one completion file.

In some embodiments, the processor determines the completion of the project upon a receipt of the approval from one of the two users via the user interface based on the at least one completion file.

In some embodiments, the processor receives payment details from one of the two users upon completion of the project via the user interface and associates the payment details with the contract document.

### BRIEF DESCRIPTION OF THE DRAWINGS

FIG. 1 illustrates a contract management system to facilitate a creation and management of a contract between two users, in accordance with an embodiment of the disclosure; and

FIG. 2 illustrates a method for creating and managing a contract between two users via the contract management system of FIG. 1, in accordance with an embodiment of the disclosure.

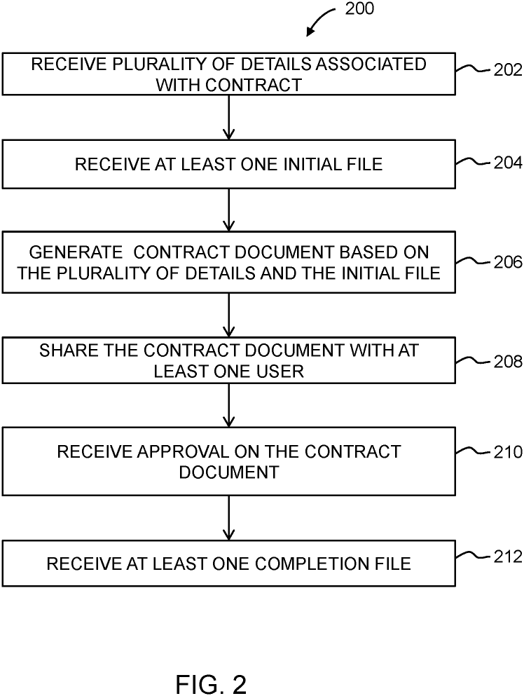

### DETAILED DESCRIPTION

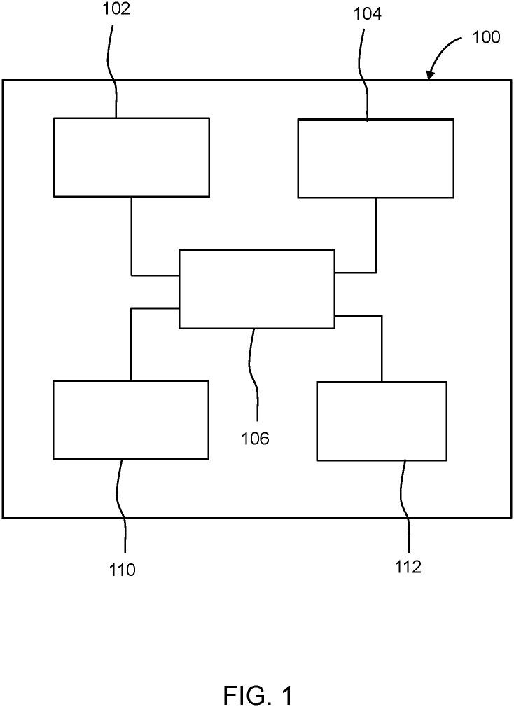

Referring to FIG. 1, a contract management system 100 to facilitate a contract between at least two users, for example, a first user (i.e., a customer) and a second user (i.e., a vendor) is shown. Although, the first user and the second user are contemplated as the customer and the vendor, respectively, it may be appreciated that the first user may be the vendor and the second user may be the customer. In an implementation, various sub-systems or the modules of the contract management system may be stored on a server and may communicate with a user device via a communication module 102. The contract management system 100 may include a user interface 104, a processor 106, and the communication module 102. The user interface 104 interacts with the users, for example, the first user and/or the second user, through a respective user device, for example, a first user device, and a second user device. The user device may be a mobile phone, a laptop, a tablet, a desktop computer, or any other similar device known in the art. In an embodiment, the user interface 104 is displayed on the user device when the user accesses the contract management system 100 by entering an address of the system 100. In an embodiment, an application may be downloaded on the user device from the server to enable a quick and easy access of the contract management system 100. The user interface 104 of the contract management system 100 is accessed by opening the application on the user device.

Further, the user interface 104 facilitates the first user and the second user to input various data into the contract management system 100, and access various data or functionalities of the contract management system 100. For example, the user interface 104 enables the first user and/or the second user to input a plurality of details into the contract management system 100 for creating and managing a contract between the first user and the second user. For example, the first user and/or the second user may input at least one details associated with the first user at least one detail associated with the second user and at least the details related to the project into the contract management system 100 via the user interface 104. In an embodiment, the at least one detail associated with the first user may include a name of the first user, an address of the first user, a contact number of the first user. Similarly, the at least one detail associated with the second user may include a name of the second user, an address of the second user, a contact number of the second user. Also, the at least one detail of the project includes one or more of a description of the work to be performed in the project, a location at which the project is to be completed, a timeline associated with a start of the project, a timeline associated with a completion of the project, a timeline of a completion of any milestones of the project, a cost associated with the project, and payment terms if any associated with the project or completion of any milestone of the project. Further, the user interface 104 enables the first user and/or the second user to upload at least one file (for example, at least one image/video file) into the contract management system 100. The user interface 104 also enables a user (i.e., the first user and/or the second user) to upload additional documents, for example, payment related documents, product related information/document, or any sub-contracting documentation/information to the contract management system 100. Also, the user interface 104 enables the first user and the second user to provide electronic signature to a contract document generated by the contract management system 100. In an embodiment, the user interface 104 enables the first user and the second user to authenticate the contract using block chain. The details received from the first user and/or the second user via the user interface 104 may be stored inside a memory of the contract management system 100 (hereinafter simply referred to as system 100).

Further, the system 100 may include an account module 110 configured to store a plurality of accounts corresponding to a plurality of users. For example, the account module 110 may include a first account corresponding to the first user, and a second account corresponding to the second user. Each account is configured to store the plurality of credentials of the user, payment account details, the project history, ongoing project details, and completed projected details etc., contract documents, of the associated user. Further, each account is associated with a username a password, and user needs to enter the username and the password for accessing the account and any information stored into the account. The account module 110 is in communication with the processor 106, and the processor 106 may access the various information associated or stored with the account upon receipt of correct username and password from the user via the user interface 104. Further, the account module 110 in combination with the processor 106 facilitates the creation/generation of the account of a new user.

Additionally, the system 100 may include a contract module 112 arranged in communication with the processor 106, the account module 110, and the user interface 104, and is adapted to facilitate generation of a contract document for a project agreed between the first user and the second user. The contract module 112 also stores the contract document. Moreover, the contract module 112 also stores various contract documents that are executed between the plurality of customers and the plurality of vendors. Further, each contract document is assigned a contract identification number that is assigned/associated with a corresponding project via a project identification number. The contract document can be accessed by the first user and the second user by accessing the respective accounts stored inside the account module 110 via the user interface. To facilitate the creation or the generation of the contract document, the contract module 122 may store/include at least one contract template.

The processor 106 is in communication with the each of the user interface 104, the account module 110, and the contract module 112 to exchange data or information and perform one or more action based on the data or information received. Also, the processor 106 may communicate with the user device via the communication module 102. Further, the processor 106 may receive various information of the users during the respective account creation via the user interface 104 and creates the login credential for each user and stores the information inside the account module 110. The processor 106 also facilitates in accessing the account of a user upon receipt of the login credential associated with the user, and displays the various information associated with the user account upon receiving the login credentials via the user interface 104.

Further, the processor 106 may facilitate in creating the contract document between the first user and the second user based on an input from the received from the customer and/or the vendor through the user interface 104 after the customer and the vendor have reached an agreement regarding execution of the project. For so doing, the processor 106 receives the inputs related to the at least one detail of the customer, the at least one detail of the vendor, and at least one detail of the project from the user interface 104. Also, the processor 106 receives at least one initial file related to the project. In an embodiment at least one initial file may be at least one image/video file depicting/describing an initial status of the project. The initial status may refer to a current condition of the location where the work is to be performed, and various jobs to be performed during the project. In some embodiment, the at least one initial file may be a proposal document that may contain the description of the various jobs that may be performed under the project, the payment terms, the pricing details, etc. For example, the project is to paint a wall of a home. In such a case, the first user or the second user may upload an image/video file of the unpainted wall via the user interface 104 and/or the proposal document related to the painting of the wall. In some embodiments, the project may be a long-term project in which tasks are recurring in nature. For example, the project may relate to taking a pet for a walk daily, tutoring, lawn maintenance, snow removal for a period of duration. In such a case, the initial file may contain/describe the nature of recurring work, milestone to be achieved during a predefined duration, payment terms, etc. In some other embodiment, the project may include buying or selling of one or more goods. In such a case, the processor 106 prompts the first user or the second user to upload one or more images/videos of the product depicting the initial condition and status of the product.

Upon receipt of the plurality of details related to the creation of the contract document and the initial file, the processor 106 may create a document by using a suitable contract template stored inside the contract module 112. In an embodiment, processor may select the contract template based on the nature of the project. For example, the processor may choose/select separate contracts based on whether the project relates to one time job, recurring job over a period of time, product sale and purchase, etc. Also, the processor 106 associates the initial file with the document to create/generate the contract document. In an embodiment, the processor 106 may embed/attach the initial file within the document or embed a link of the initial file with the document. It may be appreciated that the initial file is stored inside the memory of the system 100. In an embodiment, the initial file is stored inside the contract module 112. Further, the processor 106 may associate/link the contract document with the first account stored inside the account module 110. Accordingly, the first user may access the contract document by accessing the first account via the user interface 104.

Additionally, the processor 106 may present the prepared contract document to the first user for review, and shares/sends the contract document to the second user upon receipt of the inputs from the first user via the user interface 104. Accordingly, the processor 106 may associate the contract document with the second user and may save the contract document inside second account present inside the account module 110. Further, the processor 106 may send a notification to the second user about receipt of the contract document from the first user. The processor 106 may share the notification to the user device via the communication module 102.

Additionally, the processor 106 facilitates in viewing the contract document by the second user upon receipt of the login credential of the second user via the user interface 104 as the second user access the second account. The processor 106 also enables the second user and the first user to provide acceptance to the contract document by e-signing the contract document. In an embodiment, the processor 106 may incorporate the contract document in the block chain, and the first user and the second user may facilitate the acceptance of the contract from their unique digital identity in the block chain network. In an embodiment, the processor 106 facilitates the first user and the second user to make amendments to the contract document before receiving the acceptance from the first user and the second user. Further, the processor 106 facilitates the second user to upload at least one completion file indicating the completion of the project or any intermediate step or milestone of the project as agreed in the contract document via the user interface 104. In an embodiment, the at least one completion file may be at least one completion image/video. The at least one completion file may be uploaded by the first user or the second user. In an embodiment, the processor 106 associates the at least completion file received from the second user via the user interface 104 to the contract document which can be accessed by the first user. In an embodiment, the processor 106 may embed the at least one completion file within the document or embed a link of the completion file inside the document stored inside the contract module 112. It may be appreciated that the at least one completion file and is stored inside the memory of the system 100. The processor 106 may store the at least one completion file with a date and time stamp of upload.

In some embodiments, the processor 106 may enable the user (i.e., the second user) to upload intermediate files (for example, images/videos) corresponding to each milestone of the project completion. For example, the processor 106 may enable the vendor to upload the images/videos upon completion of 50 percent of the project. Further, the processor 106 may send a notification to the first user upon receipt of the image/video file corresponding to the completion of the milestones and/or completion of the project. In an embodiment, the user (for example, the second user) may upload the at least one completion file at the end of each predefined period of time, for example, after a month or week, in case of the project is a recuring project, for example, a dog walking project. In a scenario, the at least one completion file may be a file or an image/video depicting a delivery of the product when the project relates to the purchase and sale of a product. In an embodiment, the processor 106 may prompt the first user to inspect the work performed by the second user and provide his approval on the work by reviewing the final image/video file. Further, the processor 106 may prompt the customer to make the payment to the vendor accordingly. In an embodiment, the processor 106 may prompt the customer to enter details of the payment into the system 100 via the user interface 104. The payment details, for example, an image of the account details or an image of the payment transfer, may be uploaded by the customer via the user interface 104, and the processor may associate the payment details with the contract document. In an embodiment, the processor 106 may embed the payment details within the document or embed a link of the payment details inside the document stored inside the contract module 112. The processor 106 may store the payment details with a date and time stamp.

Referring to FIG. 3, a method 200 for generating and managing a contract between two users, for example, a first user (i.e., the vendor) and the second user (i.e., the customer) for the project for a one-time job, is now described. It may be appreciated that the method may be similarly applied for creating and managing contract for project related to recurring works and/or product sale. The method includes a step 202 at which the processor 106 receives a plurality of details associated with the contract from the first user via the user interface 104 for creating/generating a contract between the first user and the second user. For so doing the first user access the user interface 104 of the system 100 via user device, for example, a mobile phone, a laptop, a tablet, etc. In an embodiment, the plurality of details associated with the contract includes at least one detail of the customer, at least one detail of the second user, and at least one detail of the project. In some embodiments, before allowing the first user to inputs various details associated with the creation of the contract, the processor 106 may prompt, via the user interface 104, the first user to input the login credential associated with the first account of the first user. In an embodiment, the processor 106 may prompt the customer to create an account on the system 100 before allowing the first user to input various details for creating the contract.

Upon receipt of the plurality of details, the method 200 moves to a step 204. At the step 204, the processor 106 receives the at least one initial file (for example, at least one initial image/video) associated with the project to be performed. For example, the initial file may illustrate an initial status of the project including a current condition of the location of the project and/or various jobs to be completed in the project. For example, the project relates to painting of a wall. In such a case, the initial file describes the current condition of the wall to be painted and a color that need to be painted on the wall is uploaded into the system 100 by a user (for example, the first user) via the user interface 104. For receiving the at least one initial file of the project, the processor 106 may prompt the first user via the user interface 104 to upload at least one initial file associated with the project to be performed. Upon successful uploading/receipt of the initial file, the method 200 moves to a step 206.

At the step 206, the processor 106 generates the contract document by creating a contract using the plurality of details received from the first user via the user interface 104, and associating the initial file received from the first user with the document. Thereafter, the processor 106 displays the contract document to the first user for review. Upon receipt of the approval on the contract document from the first user, the processor 106 saves the contract document inside the contract module 112 and associates the contract document with the first user account for later retrieval and access.

Thereafter, the method 200 moves to a step 208 at which the processor 106 shares the contract document with the second user. The processor 106 may share the contract document with the second user by associating the contract document with an account (i.e., the second account) of the second user stored inside the account module 110. In some embodiments, the processor 106 may also share the contract document with the second user over an email of the second user. For associating the contract document with the second account of the second user, the processor 106 may prompt the first user to enter a unique identification code associated with the second account of the second user via the user interface 104. In some embodiments, the unique identification code may be an email address of the second user, a contact number of the second user, or any other code that enables identification of the account of the second user in the account module. The processor 106 associate the contract document with the second account of the second user upon receipt of the unique identification code, enabling the second user to access and view the contract document by accessing the second account.

Furter, the processor 106 may notify the second user about the receipt of the contract document from the first user. Upon receipt of the contract document, the second user may review the contract document by accessing the second account via the user interface 104 of the system 100 with the help of a user device. In an embodiment, the second user may suggest amendments to the contract document via the user interface 104. In such a case, the processor 106 may store the amended contract document highlighting the amendments in the contract document and notifies the first user about amendments proposed by the second user. In this manner, the system 100 facilitates in finalizing the contract between the two users.

Thereafter, the method 200 moves to a step 210. At the step 210, the processor 106 receives the approval from the first user and the second user on the contract document. For so doing, the processor 106 enables the first user and the second user provide electronic signature on the contract document via the user interface 104, or the processor 106 may enable the first user and the second user to authenticate the contract document using the unique digital id in the block chain. The processor 106 determines execution of the contract document upon authentication from the first user and the second user or receipt of the electronic signature from both the first user and the second user on the contract document, and stores the executed contract document inside the contract module 112, and associates the executed contract document with the accounts of the first user and the second user.

Subsequently, the method 200 may move to a step 212. At the step 212, the processor 106 receives the at least one completion file (for example, the completion image/video) from the second user via the user interface 104 illustrating the completed status of the project or the completed status of any milestone of the project. The second user or the first user may upload the completion image via the user interface 104. The processor 106, upon receipt of the at least one completion file, assigns/associates the at least one completion file to the contract document with a date and time stamp corresponding to the uploading of the at least one completion file on the system 100. Thereafter, the processor 106 may send a notification to the user, notifying the first user or the second user about uploading of the at least one completion file related to the completion of the project.

Upon receipt of the notification, or otherwise, the customer may access his/her account (i.e., the first account) on the system 100 via the user interface 104, and reviews the at least one completion file, and provide approval or comments related to the completion of project. Accordingly, the processor 106 may determine a completion of the project based on an input from the customer. For example, the processor 106, via the user interface 104, may prompt the first user to select or input a date corresponding to a completion of the project or the completion of the milestone of the project, and processor 106 determines the completion of the project or the completion of the milestone of the project upon receipt of such input or selection.

In this manner, the system 100 facilitates in completion/completion of milestone of the project as per the contract document. In an embodiment, the processor 106 may prompt the first user to enter the payment details upon completion/completion of the milestone of the project. In an embodiment, the payment details may include an image or document depicting the payment made by the first user to the second user. The processor 106, upon receipt of the payment details, may associate the payment details with the contract document with a date and time stamp, and stores the details in the contract module 112. Further, upon successful completion of the project, the processor 106 may assign rewards or scores to the profile of the users upon successful completion of the project. In an embodiment, the rewards and/or scores may be provided according to a plurality of categories, such as, but not limited to, the reliability of work, timely execution, quality of work, etc. In an embodiment, the processor 106 may determine the successful completion of the project based on inputs/feedback received from the first user and the second user.

In this manner, the contract management system 100 facilitates the adherence of the conditions of the contract between the and the vendor. The contract management system 100 facilitates a mutually binding contract between the consumer and the vendor at a very low price compared to the detailed contracts negotiated and constructed between the entities. In addition, the points/reward points/scores obtained by the consumer and the vendor may be publicly available on the profile of the consumer and the vendor to indicate adherence to the terms of the contract document carried out by the customer and the vendor. The contract management system 100 facilitates the contract negotiation, contract fulfilling, payment, and completion of the work within desired standards and by meeting the plurality of conditions of the mutually determined contract.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A contract management system for facilitating and managing a contract between two users related to a project, comprising:
a user interface adapted to be accessed via a user device to facilitate one of the two users to input a plurality of details associated with the project and upload at least one initial file describing the project; and
a processor arranged in communication with the user interface and is configured to
create a contract document by generating a document based on the plurality of details received from the user interface, and associating the at least one initial file with the document,
share the contract document with another of the two users, and
receive an authentication from the two users, via the user interface, on the contract document to execute the contract between the two users.

2. The contract management system of claim 1, wherein the plurality of details includes at least one detail of a first user of the two users, at least one detail of a second user of the two users, and at least one detail of the project.

3. The contract management system of claim 2, wherein the at least one detail of the first user includes one or more of a name of the first user, an address of the first user, and a contact number of the first user.

4. The contract management system of claim 2, wherein the at least one detail of the second user includes one or more of a name of the second user, an address of the second user, and a contact number of the second user.

5. The contract management system of claim 2, wherein the at least one detail of the project includes one or more description of the work to be performed in the project, a location at which the project is to be completed, a timeline associated with a start of the project, a timeline associated with a completion of the project, a timeline of a completion of the project, a cost associated with the project, and payment terms.

6. The contract management system of claim 1 further includes a contract module having at least one contract template, and the processor generates the document by using the at least one contract template.

7. The contract management system of claim 1 further including an account module having a first account associated with one or the two users and a second account associated with other of the two users, wherein the processor associates the contract document with the first account and the second account to enable an access of the contract document to the two users via the user interface.

8. The contract management system of claim 1, wherein the processor is configured to
receive at least one completion file via the user interface, and
determine a level of completion of the project based on the at least one completion file.

9. The contract management system of claim 8, wherein the processor determines the completion of the project upon a receipt of the approval from one of the two users via the user interface based on the at least one completion file.

10. The contract management system of claim 8, wherein the processor is configured to receive payment details from the one of the two users upon completion or partial of the project via the user interface and associates the payment details with the contract document.

11. A method for facilitating and managing a contract between two users related to a project, the method comprising:
receiving, by a processor, a plurality of details associated with the contract and at least one initial file describing the project via a user interface;
creating, by the processor, a contract document by generating a document based on the plurality of details, and associating the at least one file with the document;
sharing, by the processor, the contract document with at least one of the two users; and
receiving, by the processor, authentications from the two users, via the user interface, on the contract document to execute the contract between the two users.

12. The method of claim 11, wherein the plurality of details includes at least one detail of a first user of the two users, at least one detail of a second user of the two users, and at least one detail of the project.

13. The method of claim 12, wherein the at least one detail of the first user includes one or more of a name of the first user, an address of the first user, and a contact number of the first user.

14. The method of claim 12, wherein the at least one detail of the second user includes one or more of a name of the second user, an address of the second user, and a contact number of the second user.

15. The method of claim 12, wherein the at least one detail of the project includes one or more of a description of the work to be performed in the project, a location at which the project is to be completed, a timeline associated with a start of the project, a timeline associated with a completion of the project, a timeline of a completion of the project, a cost associated with the project, and payment terms.

16. The method of claim 11, wherein the processor generates the document by using the at least one contract template received from a contract module.

17. The method of claim 11, wherein the processor associates the contract document with a first account associated with one of the two users and a second account associated with the other of two users to enable an access of the contract document to the two users via the user interface, wherein processor access an account module to access the first account and the second account.

18. The method of claim 11 further including
receiving, by the processor, at least one completion file via the user interface, and
determining, by the processor, a level of completion of the project based on the at least one completion file.

19. The method of claim 18, wherein the processor determines the completion of the project or partial completion of the project upon a receipt of the approval from one of the two users via the user interface based on the at least one completion file.

20. The method of claim 18, wherein the processor receives payment details from one of the two users upon completion or partial of the project via the user interface and associates the payment details with the contract document.
